(19) United States
(12) Patent Application Publication
(10) Pub. No.: US 2023/0175493 A1
(43) Pub. Date: Jun. 8, 2023

(54) WIND TURBINE ROTOR BLADE

(71) Applicant: Wobben Properties GmbH, Aurich (DE)

(72) Inventors: Muhanad Mahmoud, Aurich (DE); Diethelm Godenau, Rosian (DE); Sven Krebs, Leer (DE)

(21) Appl. No.: 18/060,511

(22) Filed: Nov. 30, 2022

(30) Foreign Application Priority Data
Dec. 6, 2021 (EP) 21212511.6

(51) Int. Cl. F03D 80/40; F03D 1/06

(52) U.S. Cl. CPC F03D 80/40; F03D 1/0675; F03D 1/0658

(57) ABSTRACT

Provided is a wind turbine rotor blade with a rotor blade shell, which envelops an internal volume, and at least one cross sectional constriction for narrowing open cross sectional space of the internal volume.

### BACKGROUND

### Technical Field

The present invention relates to a wind turbine rotor blade.

### Description of the Related Art

Since the rotor blades of a wind turbine are exposed to all weather conditions without protection, the rotor blades can become iced over at certain temperatures. In order to prevent this, use can be made of a rotor blade heater. Either a heater can here be provided outside on the rotor blade, or heated air can be provided inside of the rotor blade.

A rotor blade heater is often used to prevent the rotor blades from icing over. Heater air is here typically introduced into the interior of the rotor blade in the area of the rotor blade root. The heated air in turn heats up the rotor blade shell, for example in the area of the rotor blade nose, so that a deicing of the rotor blade can be achieved.

WO 2017/021350 A1 shows a wind turbine rotor blade with a rotor blade root area and a rotor blade tip area. Also provided is at least one web along a longitudinal direction of the rotor blade. A deflection unit for deflecting the air can be provided on the web.

WO 2018/211055 shows a rotor blade of a wind turbine with a rotor blade, which has a web and a deflection unit on the rotor blade tip for deflecting heated air.

### BRIEF SUMMARY

Provided is a wind turbine rotor blade with an improved rotor blade heater.

Provided is a wind turbine rotor blade with a rotor blade shell that envelops an internal volume, and at least one cross sectional constriction for narrowing the free cross section of the internal volume. The constriction makes it possible to increase the flow rate, which leads to an improved heat transfer, and thus to an improved heating of the rotor blades.

According to an aspect of the present invention, the rotor blade has at least one web along a longitudinal direction of the rotor blade. The at least one cross sectional constriction is arranged on the at least one web, or fastened with the web.

According to another aspect of the present invention, the rotor blade has at least one first and second web along a longitudinal direction of the rotor blade. Further provided is a first air channel between a front edge of the rotor blade and a first web, wherein at least one first cross sectional constriction is provided in the first air channel.

According to another aspect of the present invention, the rotor blade has a second air channel between a web and a rotor blade trailing edge. A second cross sectional constriction is provided at least partially in the second air channel along the longitudinal direction of the rotor blade.

According to another aspect of the present invention, the rotor blade has a least one third cross sectional constriction in a third air channel between the first and second webs.

According to another aspect of the present invention, the rotor blade has a rotor blade heating system in or on the root of the rotor blade. The rotor blade heating system generates warm air, which is conveyed into the internal volume of the rotor blade.

Provided is a wind turbine with at least one wind turbine rotor blade described above.

Thus provided is a wind turbine rotor blade with a (two-part) blade shell, which envelops an internal volume. The rotor blade further has a rotor blade root and a rotor blade tip. At least one web can be provided at least sectionally between the two blade shells along a longitudinal direction of the rotor blade, so that the internal volume of the rotor blade is divided into at least two sections. The rotor blade further has a rotor blade heater, for example which is provided in the area of the rotor blade root, and conveys heated air into the internal volume of the rotor blade. To improve the effectiveness of the blade heater, at least one cross sectional constriction is provided in the internal volume, so that the free air volume in the internal volume is reduced. Furthermore, this also reduces the open cross section space for the air flow. The reduction in open cross section space produces an increased flow rate, since the rotor blade heater provides an essentially constant air volume flow. The increased flow rate is accompanied by an improved heat transfer to the rotor blade shells, so that an improved rotor blade heater can be achieved by providing the cross sectional constrictions.

There is thus a reduction in the open cross sectional space, through which the heated air can be conveyed.

According to an aspect of the present invention, a web is provided between the two blade shells (pressure side, suction side), so that an air channel comes about in the area of the rotor blade front edge, through and along which the air heated by the rotor blade heater can flow. At least one first cross sectional constriction is provided in the area of the first channel, at least partially along a longitudinal axis of the rotor blade.

According to another aspect of the present invention, a second web is provided between the two rotor blade shells, so that a second channel arises in the area of the rotor blade trailing edge. An optional second cross sectional constriction can be provided in this second channel, so that the open cross section space of the second channel for the air flow is reduced.

According to an aspect of the present invention, a third channel can be provided at least partially between the first and second webs. Third cross sectional constrictions can optionally be provided in the third channel, so as to reduce the open cross sectional space.

According to an aspect of the present invention, a first cross sectional constriction can be provided in the area of a rotor blade length of 20 to 30 m (meters).

According to another aspect of the present invention, three first cross sectional constrictions can be provided in the first channel along a longitudinal axis of the rotor blade, wherein a first cross sectional constriction can be provided at a rotor blade length of between 10 and 15 m, a second cross sectional constriction within a rotor blade length range of 20 to 25 m, and/or a third cross sectional constriction within a rotor blade length range of 30 to 35 m.

The flow rate (arising from the volume flow and cross section) is increased by reducing the open cross sectional space in a ventilation channel. The increase in flow rate is also accompanied by a rise in the heat transfer coefficient α.

A change in the blade internal flow takes place to improve a heat transfer of the heated air from the blade heater to the rotor blade shell.

The cross sectional constrictions represent passive options for increasing the flow rate.

According to an aspect of the invention, the cross sectional constrictions can be installed retroactively.

Additional configurations are the subject of the subclaims.

### BRIEF DESCRIPTION OF THE SEVERAL VIEWS OF THE DRAWINGS

Advantages and exemplary embodiments of the invention will be explained in more detail below with reference to the drawing.

FIG. 1 shows a schematic view of a wind turbine according to the invention,

FIGS. 2A and 2B show a schematic cross section and a schematic longitudinal section of a rotor blade according to prior art,

FIG. 3A shows a schematic cross section of a rotor blade according to an aspect of the invention,

FIG. 3B shows a schematic longitudinal section of a rotor blade according to FIG. 3A,

FIG. 4A shows a schematic cross section of a first portion of a rotor blade,

FIG. 4B shows a schematic cross section of a portion of the rotor blade according to an aspect of the present invention, as well as a schematic longitudinal section of a rotor blade according to an aspect of the present invention,

FIG. 4C shows a schematic cross section of a portion of a rotor blade and a longitudinal section of a rotor blade according to an aspect of the present invention,

FIG. 5A shows a graph for illustrating a surface temperature of a rotor blade for the exemplary embodiments shown on FIGS. 4A, 4B and 4C,

FIG. 5B shows a graph for illustrating a heat transfer coefficient α as a function for the three exemplary embodiments on FIGS. 4A, 4B and 4C,

FIG. 5C shows a graph for illustrating a heat output L for the exemplary embodiments on FIGS. 4A, 4B and 4C, and

FIG. 6 shows a graph for illustrating a fluid temperature for the exemplary embodiments on FIGS. 4A, 4B and 4C.

### DETAILED DESCRIPTION

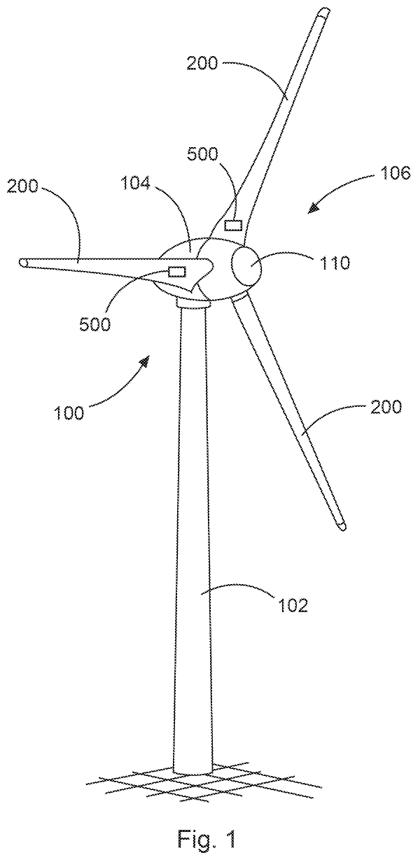

FIG. 1 shows a schematic view of a wind turbine according to the invention. The wind turbine 100 has a tower 102 and a nacelle 104 on the tower 102. Provided on the nacelle 104 is an aerodynamic rotor 106 with three rotor blades 200 and a spinner 110. During operation of the wind turbine, the wind imparts a rotational motion to the aerodynamic rotor 106, which thus also turns a rotor or runner of a generator, which is directly or indirectly coupled with the aerodynamic rotor 106. The electric generator is arranged in the nacelle 104, and generates electric energy. The pitch angles of the rotor blades 200 can be changed by pitch motors on the rotor blade roots of the respective rotor blades 200.

A rotor blade heater 500 can be provided in the area of a rotor blade root for purposes of rotor blade deicing. As an alternative thereto, the rotor blade heater 500 can be provided in an area of a rotor hub or on a rotor blade connector. The rotor blade heater 500 generates hot air, and then conducts it into the interior of the rotor blade to deice the rotor blade or prevent icing.

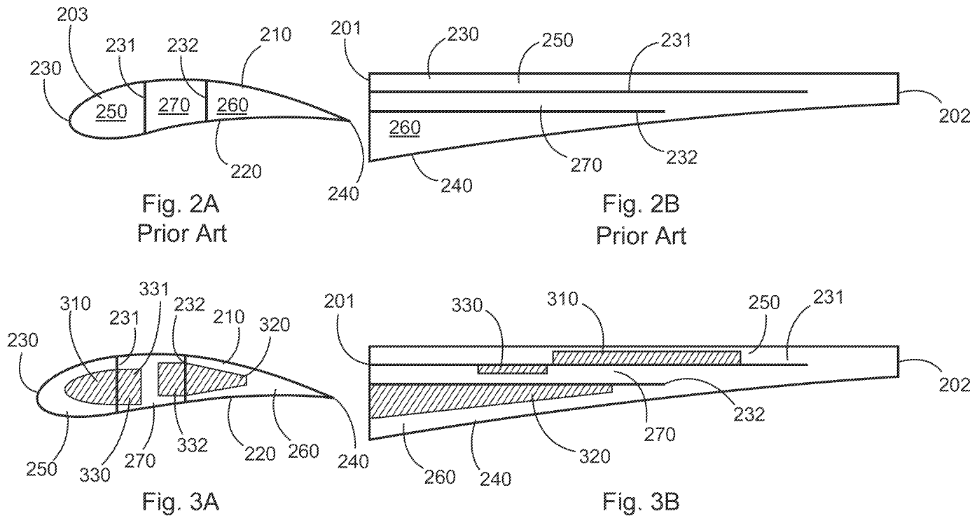

FIG. 2A shows a cross section of a rotor blade, and FIG. 2B shows a longitudinal section of a rotor blade. The rotor blade 200 has two blade shells 210, 220, which envelop an internal volume 203. The rotor blade 200 further has a rotor blade leading edge 230 and a rotor blade trailing edge 240. Webs 231, 232 can be provided between the blade shells 210, 220, so that the internal volume 203 can be divided into various portions or channels 250, 260 and 270 (first channel 250 between the leading edge 230 and first web 231, second channel 260 between the trailing edge 240 and second web 232, and third channel 270 between the first and second webs 231, 232). For example, the web 231 can be longer than the web 232.

FIGS. 3A and 3B show a corresponding cross section of a rotor blade as well as a longitudinal section of the rotor blade according to an exemplary embodiment of the invention. While the channels 250, 260 and 270 are shown unchanged in the rotor blade according to FIGS. 2A and 2B, at least portions of the channels according to FIGS. 3A and 3B are provided with cross sectional constrictions 310 in the first channel 250, with second cross sectional constrictions 320 in the second channel 260 and/or optionally with third cross sectional constrictions 330 in the third channel 270. FIG. 3B shows the distribution of the cross sectional constrictions 310, 320, 330 along a longitudinal axis of the rotor blade.

Both the cross sections of the cross sectional constrictions and their distribution along the longitudinal axis of the rotor blade can differ from the cross sections and longitudinal distributions shown on FIGS. 3A and 3B.

The cross sectional constrictions result in a higher flow rate of the air flowing through the rotor blade heater 500 into the interior (into the channels 250, 260, 270) of the rotor blade.

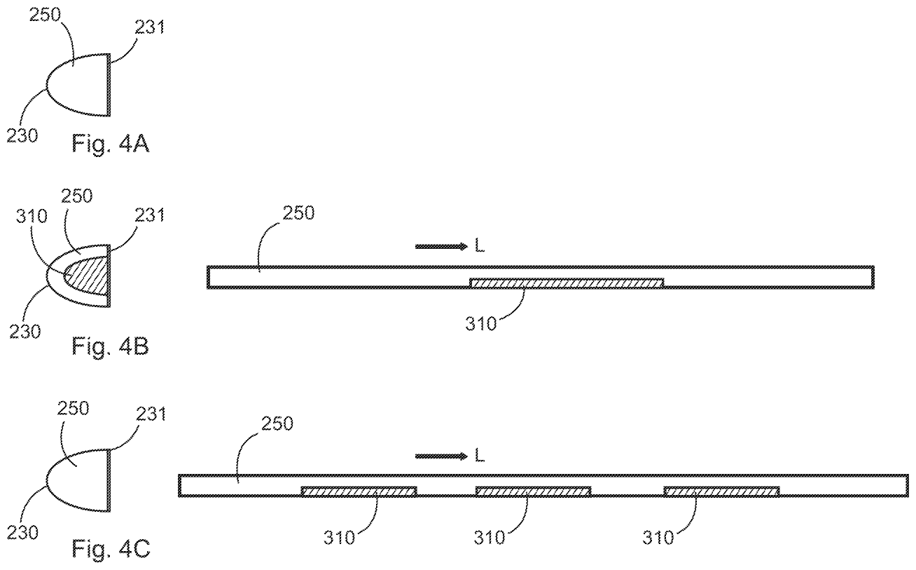

FIG. 4A shows a schematic cross section of a first channel on FIG. 3A. No cross sectional constrictions are provided in the first channel 250.

On FIG. 4B, cross sectional constrictions are provided in the first channel 250 according to one exemplary embodiment of the invention. FIG. 4B also shows the distribution of the cross sectional constrictions in a schematic longitudinal section. For example, the cross sectional constrictions 310 can here be provided between a rotor blade length or a radius of 20 to 30 m.

FIG. 4C shows a schematic cross section of a first channel, as well as a schematic longitudinal section of the first channel. According to FIG. 4C, the cross sectional constrictions 310 can be provided at three locations along the rotor blade longitudinal axis, specifically at an exemplary rotor blade radius of 10 to 15 m, 20 to 25 m, and 30 to 35 m.

Therefore, FIG. 4A shows the case without cross sectional constrictions, FIG. 4B shows the case with a cross sectional constriction, and FIG. 4C shows an exemplary embodiment with three cross sectional constrictions.

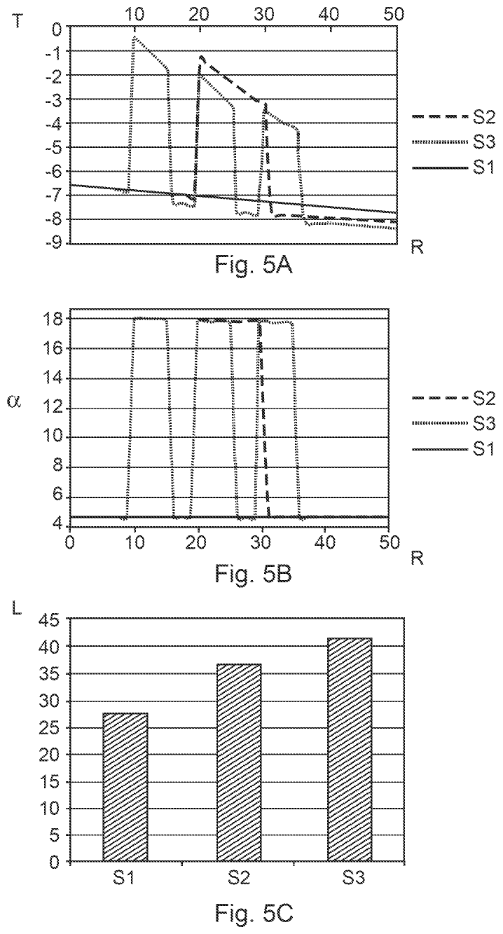

FIG. 5A shows a graph, which depicts a dependence of the surface temperature on the radius R of the rotor blade for the exemplary embodiments on FIG. 4A (S1), FIG. 4B (S2) and FIG. 4C (S3). In the exemplary embodiment on FIG. 4A, a linear decrease in surface temperature can be discerned along the radius R of the rotor blade. In the second and third exemplary embodiments on FIG. 4B and FIG. 4C, there are increases in temperature in the area of the cross sectional constrictions.

FIG. 5B shows a dependence between the heat transfer coefficient α and the radius R. No change is evident in the exemplary embodiment S1 on FIG. 4A. A respective increase in the heat transfer coefficient α in the area of the cross sectional constrictions is evident in the exemplary embodiment S2 on FIG. 4B and S3 on FIG. 4C.

FIG. 5C shows a heat output L for the above three exemplary embodiments S1, S2 and S3. As evident from FIG. 4, the heat output rises with the increasing use of the cross sectional constrictions.

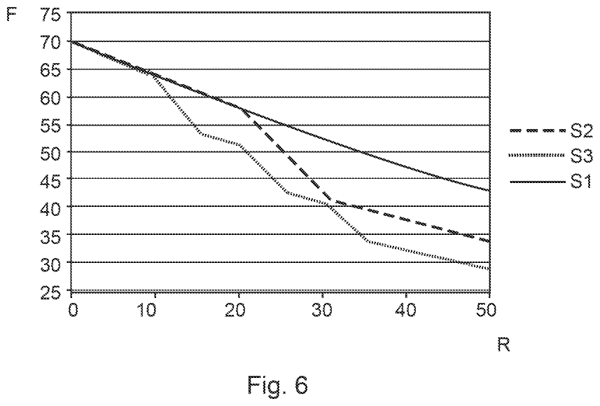

FIG. 6 shows a dependence of the fluid temperature on the radius R. In the first exemplary embodiment S1 on FIG. 4A, there is a linear decrease in fluid temperature. A stronger decrease in fluid temperature is shown in the exemplary embodiments S2 and S3, wherein a stronger drop in fluid temperature is still present in particular in the area of the cross sectional constrictions.

According to an aspect of the present invention, the cross sectional constrictions can be used given channel cross sections with a surface area of 30,000 mm² to 100,000 mm², for example.

### REFERENCE LIST

100 Wind turbine
102 Tower
104 Nacelle
106 Rotor
110 Spinner
200 Rotor blades
203 Internal volume
210 Blade shells
220 Blade shells
230 Rotor blade leading edge
231 Webs
232 Webs
240 Rotor blade trailing edge
250 Channels
260 Channels
270 Channels
310 Cross sectional constrictions
320 Cross sectional constrictions
330 Cross sectional constrictions
500 Rotor blade heater

The various embodiments described above can be combined to provide further embodiments. These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A wind turbine rotor blade, comprising:
a rotor blade shell having an internal volume, and
a cross sectional constriction in the internal volume that narrows open cross sectional space in the internal volume.

2. The wind turbine rotor blade according to claim 1, further comprising:
a web extending along a longitudinal direction of the rotor blade,
wherein the cross sectional constriction is arranged on the web.

3. The wind turbine rotor blade according to claim 1, comprising:
first and second webs along a longitudinal axis of the rotor blade, and
a first air channel between a leading edge of the rotor blade and the first web, wherein the cross sectional constriction is located in the first air channel.

4. The wind turbine rotor blade according to claim 3, comprising a second air channel between the second web and a rotor blade trialing edge, wherein the cross sectional constriction is a first cross sectional constriction, wherein a second cross sectional constriction is located at least partially in the second air channel and extends along the longitudinal direction of the rotor blade.

5. The wind turbine rotor blade according to claim 4, comprising a third cross sectional constriction in a third ventilation channel between the first and second webs.

6. The wind turbine rotor blade according to claim 1, comprising a rotor blade root, and a rotor blade heating system at the rotor blade root, wherein the rotor blade heating system is configured to generate heated air and convey the heated air into the internal volume of the rotor blade shell.

7. A wind turbine comprising at least one wind turbine rotor blade according to claim 1.
